(19) United States
(12) Patent Application Publication
(10) Pub. No.: US 2006/0200606 A1
(43) Pub. Date: Sep. 7, 2006

(54) Bus connection method and apparatus

(75) Inventors: Shin-wook Kang, Suwon-si (KR); Sung-kyu Choi, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/304,614

(22) Filed: Dec. 16, 2005

(30) Foreign Application Priority Data
Mar. 5, 2005 (KR) 10-2005-0018435

(51) Int. Cl. G06F 13/00

(52) U.S. Cl. 710/110

(57) ABSTRACT

A system-on-chip (SOC) based on an advanced micro-controller bus architecture (AMBA), and particularly, a bus connection method, is provided. The bus connection method includes: allowing one of a plurality of masters to use a plurality of slaves; generating information necessary for using the slaves by decoding a command generated by the master allowed to use the slaves; and outputting signals with reference to the generated information according to a protocol of a bus system to which the slaves are connected. Accordingly, it is possible to transmit data in a pipeline approach by applying bank interleaving to an occasion when only one master issues a request for the reading or writing of data in units of blocks.

### CROSS-REFERENCE TO RELATED PATENT APPLICATION

This application claims priority from Korean Patent Application No. 10-2005-0018435, filed on Mar. 5, 2005, in the Korean Intellectual Property Office, the disclosure of which is incorporated herein in its entirety by reference.

### BACKGROUND OF THE INVENTION

1. Field of the Invention

The present invention relates to an advanced micro-controller bus architecture (AMBA)-based system-on-chip (SOC), and more particularly, to a bus connection method and apparatus.

2. Description of the Related Art

Recently, in accordance with an ever growing demand for various multimedia functions, an increasing number of masters that can serve multimedia functions have been developed, and the amount of data that can be processed by such masters has increased.

FIG. 1 is a block diagram of a conventional system-on-chip (SOC). Referring to FIG. 1, the conventional SOC includes a plurality of masters 11 through 14 (Masters 0 through 3), a plurality of bus systems 15 and 16, and a plurality of Dynamic Random Access Memories (DRAMs) 17 and 18. In general, an SOC is based on an advanced micro-controller bus architecture (AMBA).

Each of the masters 11 though 14 includes a master core and a direct memory access (DMA). In general, the DRAMs 17 and 18 serve as slaves for the masters 11 through 14, and in particular, the banks of the DRAMs 17 and 18 serve as slaves.

Each of the bus systems 15 and 16 includes an arbitrator, which allows one of the masters 11 through 14 to use a bus, and a decoder, which selects a slave allotted to the master allowed to use the bus by decoding an address provided by the corresponding master. Detailed descriptions of the bus systems 15 and 16 are presented in the AMBA standard and thus will be skipped here.

FIG. 2 is a timing diagram illustrating the operations of the masters 11 and 12 of the conventional SOC of FIG. 1. Specifically, the upper half of FIG. 2 illustrates a case in which the masters 11 and 12 do not simultaneously operate. In this case, only one of the masters 11 and 12 can use only one memory bank in a command phase (CMD Phase) when a command is transmitted and in a data phase (Data Phase) when data is transmitted. Thus, bank interleaving cannot be applied to the masters 11 and 12, so data is transmitted intermittently.

The lower half of FIG. 2 illustrates a case where the masters 11 and 12 simultaneously operate. In this case, the data phase of the master 11 may coincide with the command phase of the master 12, and the command phase of the master 11 may coincide with the data phase of the master 12. Therefore, bank interleaving can be applied to the masters 11 and 12, so data can be consecutively transmitted.

In reality, however, a plurality of masters, i.e., a plurality of codecs, rarely operate at the same time. Therefore, bank interleaving is not likely to be applied to a conventional SOC, thereby failing to maximize bus efficiency.

In addition, codecs of one conventional SOC are likely to be mistakenly identified as codecs of another conventional SOC, in which case, a protocol of a corresponding bus system is changed. Once a protocol of a bus system of a conventional SOC is changed, masters in the conventional SOC must be modified, which may undesirably delay the design of a new SOC.

### SUMMARY OF THE INVENTION

The present invention provides a bus connection method and apparatus, which enable bank interleaving to be applied to an occasion when only one master issues a request for the reading or writing of data in units of blocks and enable masters of one SOC to be easily reused by another SOC, and a computer-readable recording medium storing a computer program for executing the bus connection method.

According to an aspect of the present invention, there is provided a bus connection method. The bus connection method includes: allowing one of a plurality of masters to use a plurality of slaves; generating information necessary for using the slaves by decoding a command generated by the master allowed to use the slaves; and outputting signals with reference to the generated information according to a protocol of a bus system to which the slaves are connected.

According to another aspect of the present invention, there is provided a bus connection apparatus. The bus connection apparatus includes: an arbitrator, which allows one of a plurality of masters to use a plurality of slaves; a decoder, which generates information necessary for using the slaves by decoding a command received from the master allowed to use the slaves; and an interface, which outputs signals with reference to the generated information according to a protocol of a bus system to which the slaves are connected.

According to another aspect of the present invention, there is provided a computer-readable recording medium storing a computer program for executing a bus connection method. The bus connection method includes: allowing one of a plurality of masters to use a plurality of slaves; generating information necessary for using the slaves by decoding a command received from the master allowed to use the slaves; and outputting signals with reference to the generated information according to a protocol of a bus system to which the slaves are connected.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional system-on-chip (SOC);

FIG. 2 is a timing diagram illustrating the operations of masters of the conventional SOC of FIG. 1;

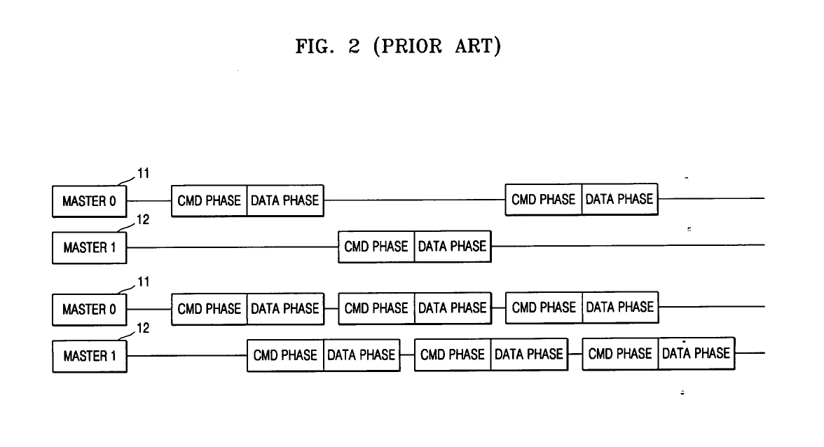

FIG. 3 is a block diagram of an SOC according to an exemplary embodiment of the present invention;

FIG. 4 is a detailed block diagram of a bus connection apparatus of FIG. 3;

FIG. 5 is a diagram illustrating an example of a memory map used for reading or writing data in units of blocks;

FIG. 6 is a diagram illustrating the operation of the conventional SOC of FIG. 1 to which the memory map of FIG. 5 is applied;

FIG. 7 is a diagram illustrating the operation of the SOC of FIG. 3 to which the memory map of FIG. 5 is applied; and

FIG. 8 is a flowchart illustrating a bus connection method according to an exemplary embodiment of the present invention.

### DETAILED DESCRIPTION OF THE INVENTION

The present invention will now be described more fully with reference to the accompanying drawings in which exemplary embodiments of the invention are shown.

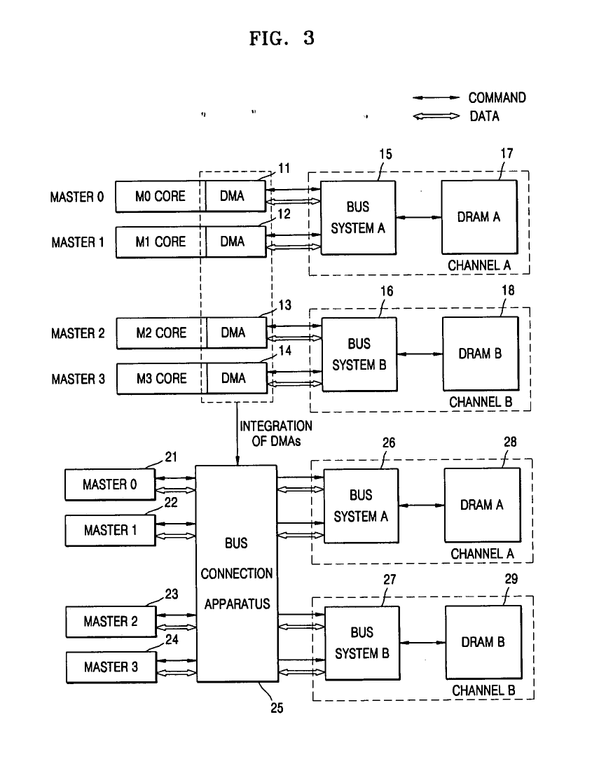

FIG. 3 is a block diagram of a system-on-chip (SOC) according to an exemplary embodiment of the present invention. Referring to FIG. 3, the SOC includes a plurality of masters (Masters 0 through 3) 21 through 24, a bus connection apparatus 25, a plurality of bus systems 26 and 27, and a plurality of DRAMs 28 and 29. The SOC is based on an advanced micro-controller bus architecture (AMBA). It is obvious to one of ordinary skill in the art that the SOC may also include elements, other than those illustrated in FIG. 3, such as a micro-processor.

The masters 21 through 24 are comprised of core parts of conventional masters 11 through 14 (Masters 0 through 3), respectively, e.g., codecs of the conventional masters 11 through 14. The DRAMs 28 and 29 serve as slaves for the masters 21 through 24. In particular, in the present exemplary embodiment, each of a plurality of banks of each of the DRAMs 28 and 29 serves as a slave for the masters 21 through 24.

The bus systems 26 and 27 have the same structure and perform the same functions as conventional bus systems 15 and 16. In other words, each of the bus systems 26 and 27 includes an arbitrator, which allows one of the masters 11 through 14 to use a bus, and a decoder, which selects a slave allotted to the master allowed to use the bus by decoding an address provided by the corresponding master. Detailed descriptions of the bus systems 15 and 16 are presented in the AMBA standard and thus will be skipped here.

The bus connection apparatus 25 is an apparatus into which direct memory accesses (DMAs) of the conventional masters 11 through 14 are integrated. The bus connection apparatus 25 allows only one of the masters 21 through 24 to use the banks of the DRAMs 28 and 29, generates information necessary for using the banks of the DRAMs 28 and 29 as slaves by decoding a command received from the corresponding master, and outputs master signals according to one of the protocols of the bus systems 26 and 27 to which the DRAMs 28 and 29 are connected. In short, the bus connection apparatus 25 enables one codec to use a plurality of banks of each of a plurality of DRAMs as slaves.

However, in order to enable the masters 21 through 24 to simultaneously use the banks of the DRAMs 28 and 29, as many advanced high-performance bus (AHB) interfaces as the number of banks of the DRAMs 28 and 29 multiplied by the number of masters (i.e., codecs) must be installed between the masters 21 through 24 and the banks of the DRAMs 28 and 29, which makes it difficult to design an integrated field programmable gate array (FPGA) and respond timely to changes to the bus systems 26 and 27. Therefore, the bus connection apparatus 25 allows only one of the masters 21 through 24 at a time to use the banks of the DRAMs 28 and 29 so that only the master allowed to use the banks of the DRAMs 28 and 29 uses the banks of the DRAMs 28 and 29.

Accordingly, in the present embodiment, it is possible to reduce the logic size of an SOC by integrating DMAs of the conventional masters 11 through 14 into the bus connection apparatus 25 and reducing the number of AHB interfaces required.

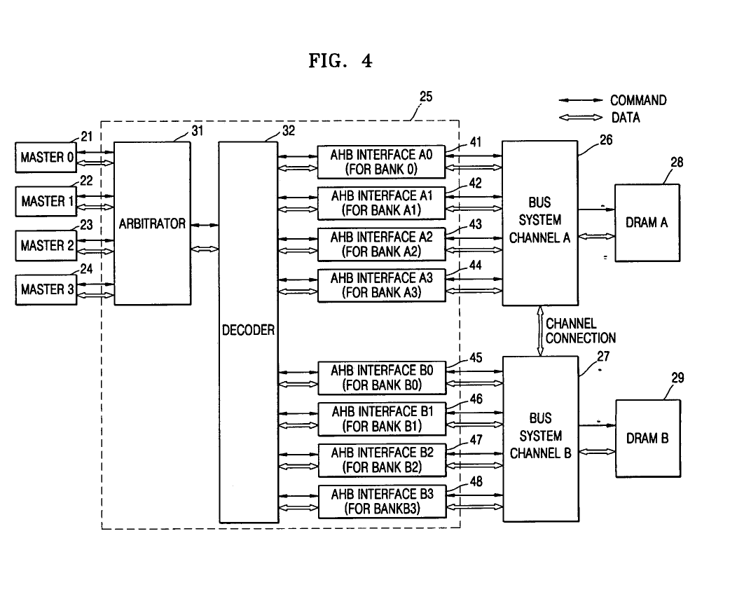

FIG. 4 is a detailed block diagram of the bus connection apparatus 25 of FIG. 3. Referring to FIG. 3, the bus connection apparatus 25 includes an arbitrator 31, a decoder 32, and a plurality of AHB interfaces 41 through 44 (A0 through A3) and 45 through 48 (B0 through B3). The AHB interfaces 41 through 44 are connected to a bus system A that uses channel A, and the HAB interfaces 45 through 48 are connected to a bus system B that uses channel B.

The arbitrator 31 allows one of a plurality of masters to use a plurality of slaves. In detail, when receiving a plurality of commands from the masters, the arbitrator 31 determines the priority levels of the masters based on the order in which the commands issued by the masters arrive and the importance of the commands issued by the masters and allows one of the masters having the highest priority level to use the slaves. Thereafter, once communications between the master having the highest priority level and the slaves are complete, the arbitrator 31 allows the master having the second highest priority level to use the slaves.

For example, suppose that the masters are codecs and the slaves are memory banks. When a read or write command containing information regarding a data transmission method and data size is received by the codecs, the arbitrator 31 allows one of the codecs to use the memory banks. If the masters are MPEG codecs, they issue a read or write command specifying that data is to be read or written in units of 8×8 macroblocks.

The decoder 32 decodes a command provided by the master allowed to use the slaves by the arbitrator 31, thereby generating information required for using the slaves. In detail, the decoder 32 allots a channel to the master allowed to use the slaves by the arbitrator 31 by decoding the command received from the corresponding master and determines which of the slaves use the allotted channel. Thereafter, the decoder 32 generates the address information and the control information of the slaves that are determined to use the allotted channel.

For example, if the masters are various types of codecs and the slaves are memory banks, the decoder 32 generates address information and control information specifying the reading or writing of data in units of lines on a memory map by decoding a command containing information regarding a data transmission method and data size. Here, the memory map maps the codecs to the memory banks.

The AHB interfaces 41 through 48 output AHB master signals with reference to the address information and the control information generated by the decoder 32 according to a protocol of the bus system 26 or 27. In the present embodiment, the AHB interfaces 41 through 48 output the AHB master signals in a pipeline approach in order to quickly process commands issued by the masters.

The AHB interfaces 41 through 48 output the AHB master signals respectively corresponding to the masters. Thus, from the viewpoint of the bus system 26 or 27, the AHB interfaces 41 through 48 may look like masters. Therefore, in a case where a bus system, other than the bus system 26 or 27, is connected to the bus connection apparatus 25, the masters can be easily reused by an SOC, other than the SOC where they belong, by changing the AHB interfaces 41 through 48 according to a protocol of the bus system, other than the bus system 26 or 27, without the need to change master cores.

For example, if the masters are various types of codecs and the slaves are memory banks, the AHB interfaces 41 through 48 correspond to DMAs allotted to the respective memory banks, in which case, the AHB interfaces 41 through 48 output the AHB master signals following the protocol of the bus system 26 or 27 in the pipeline approach so that data can be read from or written to the memory banks in an interleaving method.

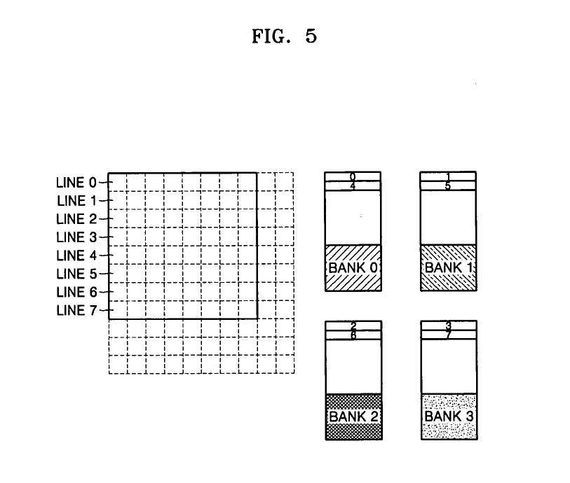

FIG. 5 is a diagram illustrating an example of a memory map used for reading or writing data in units of blocks. Referring to FIG. 5, line 0 of an 8×8 macroblock is allotted to a first line of memory bank 0, line 1 of an 8×8 macroblock is allotted to a first line of memory bank 1, line 2 of an 8×8 macroblock is allotted to a first line of memory bank 2, and line 3 of an 8×8 macroblock is allotted to a first line of memory bank 3.

Line 4 of an 8×8 macroblock is allotted to a second line of memory bank 0, line 5 of an 8×8 macroblock is allotted to a second line of memory bank 1, line 6 of an 8×8 macroblock is allotted to a second line of memory bank 2, and line 7 of an 8×8 macroblock is allotted to a second line of memory bank 3.

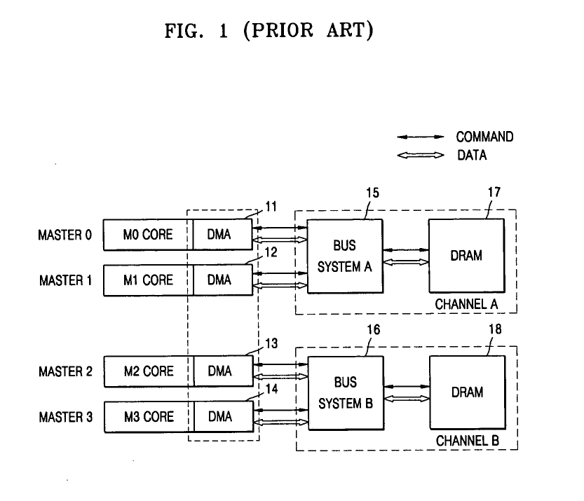

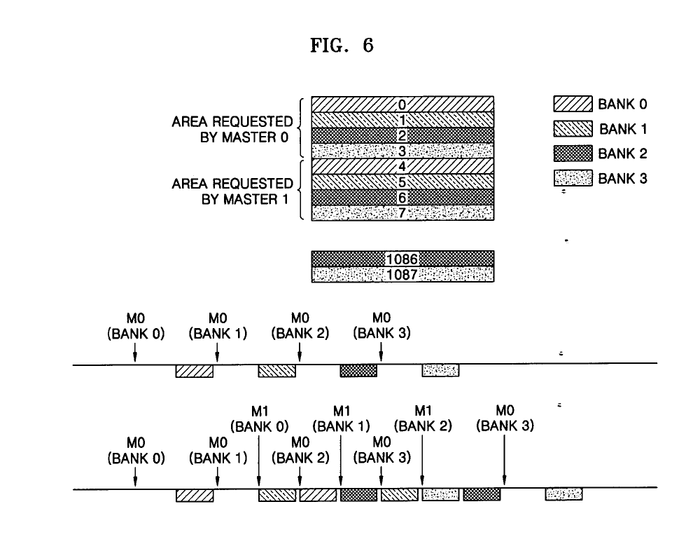

FIG. 6 is a diagram illustrating the operation of the conventional SOC of FIG. 1 to which the memory map of FIG. 5 is applied. The upper half of FIG. 6 illustrates a case where master 0 (11) issues a request for the reading/writing of data from/to blocks constituting lines 0 through 3 of FIG. 5. In this case, master 0 (11) can use only one memory bank in a command phase and in a data phase. Thus, bank interleaving cannot be used meaning that data is transmitted only intermittently. In other words, if only one master in the conventional SOC issues a request for the reading/writing of data in units of blocks, data can be transmitted in a pipeline approach.

The lower half of FIG. 6 illustrates a case where master 0 (11) issues a request for the reading/writing of data from/to the blocks constituting lines 0 through 3 of FIG. 5, and master 1 (12) issues a request for the reading/writing of data from/to blocks constituting lines 4 through 7 of FIG. 5. In this case, a data phase of master 0 (11) may coincide with a command phase of master 1 (12), and a command phase of master 0 (11) may coincide with a data phase of master 1 (12). Thus, bank interleaving can be used so that data can be consecutively transmitted. In other words, if a plurality of masters in the conventional SOC issue a request for the reading or writing of data in units of blocks, data can be transmitted in the pipeline approach.

In reality, however, a plurality of masters, i.e., a plurality of codecs, are not likely to issue a request for the reading or writing of data in units of blocks at the same time. Thus, bank interleaving is not applied to the conventional SOC, thus failing to transmit data in the pipeline approach.

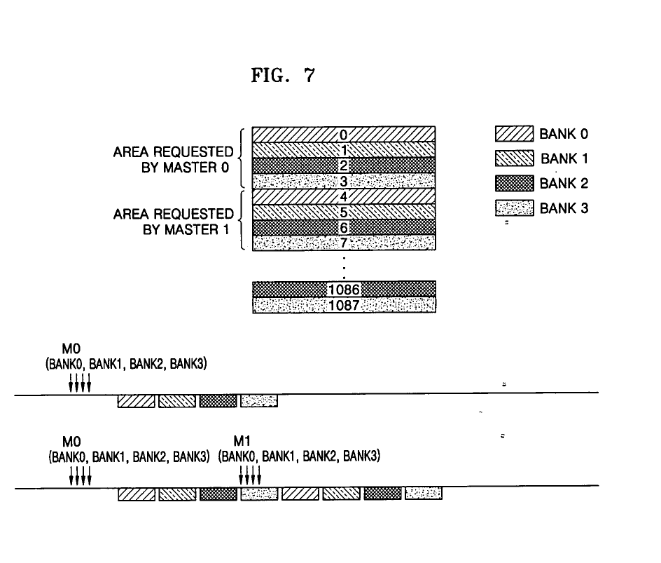

FIG. 7 is a diagram illustrating the operation of the SOC of FIG. 3 to which the memory map of FIG. 5 is applied. The upper half of FIG. 7 illustrates a case where master 0 (21) issues a request for the reading/writing of data from/to the blocks constituting lines 0 through 3 of FIG. 5. In this case, master 0 (21) can use a plurality of memory banks in a command phase and in a data phase. Thus, master 0 (21) can consecutively transmit data through bank interleaving. In other words, if only one master in the SOC according to an exemplary embodiment of the present invention issues a request for the reading/writing of data in units of blocks, data can be transmitted in the pipeline approach.

The lower half of FIG. 7 illustrates a case where master 0 (21) issues a request for the reading/writing of data from/to the blocks constituting lines 0 through 3 of FIG. 5, and master 1 (22) issues a request for the reading/writing of data from/to the blocks constituting lines 4 through 7 of FIG. 7. In this case, master 0 (21) has a higher priority level than master 1(22) and thus is allowed to use memory banks first. Thereafter, master 1 (22) is allowed to use the memory banks. Therefore, bank interleaving can be applied to a plurality of masters in the SOC according to an exemplary embodiment of the present invention so that data can be consecutively transmitted by master 0 (21) and master 1 (22). In other words, if the masters in the SOC according to an exemplary embodiment of the present invention issue a request for the reading or writing of data in units of blocks, data can be transmitted in the pipeline approach. Therefore, data is always transmitted in the pipeline approach in the SOC according to an exemplary embodiment of the present invention, thereby maximizing bus efficiency.

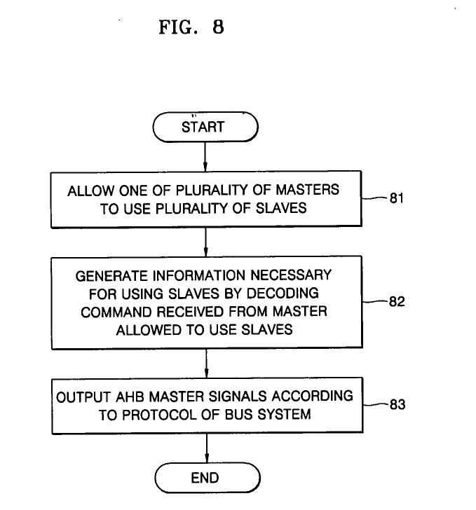

FIG. 8 is a flowchart illustrating a bus connection method according to an exemplary embodiment of the present invention. The bus connection method according to an exemplary embodiment of the present invention includes processes performed by the bus connection apparatus 25 of FIG. 4. Thus, the above description of the bus connection apparatus 25 of FIG. 4 is directly applicable to the bus connection method according to an exemplary embodiment of the present invention.

Referring to FIG. 8, in operation 81, the bus connection apparatus 25 allows one of a plurality of masters to use a plurality of slaves. In detail, in operation 81, the bus connection apparatus 25 receives a plurality of commands from the masters, determines which of the masters has a highest priority level with reference to an order in which the commands issued by the masters have arrived or the priority levels of the commands issued by the masters, and allows the master having the highest priority level to use the slaves. Thereafter, if the operation of the master having the highest priority level with the slaves is complete, the master having the second highest priority level is allowed to use the slaves.

In operation 82, the bus connection apparatus 25 generates information necessary for using the slaves by decoding a command received from the master allowed to use the slaves in operation 81. In detail, the bus connection apparatus 25 allots a channel to the master allowed to use the slaves in operation 81 by decoding the command received from the corresponding master, and determines which of the slaves use the allotted channel. The bus connection apparatus 25 generates address information and control information regarding the slaves using the allotted channel based on the determination results.

In operation 83, the bus connection apparatus 25 outputs AHB master signals based on the address information and the control information generated in operation 82 according to a protocol of the bus system 26 or 27 (both of FIG. 4), to which the slaves using the allotted channel are connected. In the present embodiment, the bus connection apparatus 25 outputs the AHB master signals in a pipeline approach to quickly process the command provided by the master allowed to use the slaves in operation 81.

The embodiments of the present invention can be realized as a computer program that can be recorded on a computer-readable recording medium and then executed on a digital computer. In addition, data structures used in the embodiments of the present invention can be recorded on the computer-readable recording medium in various manners.

Examples of the computer-readable recording medium include a magnetic storage medium (e.g., a ROM, a floppy disc, or a hard disc), an optical storage medium (e.g., a CD-ROM or a DVD), and a carrier wave (e.g., data transmission through the Internet).

According to the present invention, it is possible to transmit data in a pipeline approach by applying bank interleaving to an occasion when only one master issues a request for the reading or writing of data in units of blocks. Accordingly, data is always transmitted in the pipeline approach in the SOC according to the present invention, thereby maximizing bus efficiency.

Moreover, even when an SOC recognizes masters belonging to another SOC, it can easily use the masters by modifying the bus connection apparatus according to the present invention, and particularly, AHB interfaces. Furthermore, it is possible to reduce the logic size of an SOC by integrating DMAs of conventional masters into the bus connection apparatus according to the present invention and reducing the number of AHB interfaces.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A bus connection method comprising:
allowing one of a plurality of masters to use a plurality of slaves;
generating information necessary for using the slaves by decoding a command generated by the master allowed to use the slaves; and
outputting signals with reference to the generated information according to a protocol of a bus system to which the slaves are connected.

2. The bus connection method of claim 1, wherein the signals comprise master signals and the outputting comprises outputting the master signals for the slaves using a pipeline approach.

3. The bus connection method of claim 2, wherein the slaves comprise memory banks, and the outputting of the master signals comprises performing an interleaving read or write operation on the memory banks.

4. The bus connection method of claim 1, wherein the signals are master signals and the outputting comprises outputting the master signals to each of a plurality of channels according to a protocol of the bus system.

5. The bus connection method of claim 1, wherein in the generating of the information: a channel is allotted to the master allowed to use the slaves by decoding the command received from the master allowed to use the slaves, it is determined which of the slaves use the allotted channel, and the information necessary for using the slaves is generated based on the determination results.

6. The bus connection method of claim 1, wherein the slaves are memory banks, and the generating information comprises generating address information and control information that specify the reading or writing of data in units of lines on a memory map.

7. The bus connection method of claim 6, wherein the address information and control information are generated by decoding a command containing information regarding the reading/writing of data from/to the memory banks in units of blocks, wherein the memory map comprises mapping information of the masters and the memory banks.

8. The bus connection method of claim 1, wherein the master allowed to use the plurality of slaves is determined based on priority levels of the masters.

9. The bus connection method of claim 8, wherein the priority levels of the masters are based on the order in which the commands issued by the masters arrive and the importance of the commands issued by the masters.

10. A bus connection apparatus comprising:
an arbitrator, which allows one of a plurality of masters to use a plurality of slaves;
a decoder, which generates information necessary for using the slaves by decoding a command received from the master allowed to use the slaves; and
an interface, which outputs signals with reference to the generated information according to a protocol of a bus system to which the slaves are connected.

11. The bus connection apparatus of claim 10, wherein the interface outputs master signals for the slaves in a pipeline approach.

12. The bus connection apparatus of claim 11, wherein the slaves comprise memory banks, and the interface outputs the master signals using the pipeline approach so that an interleaving read or write operation is performed on the memory banks.

13. The bus connection apparatus of claim 10, wherein the interface outputs master signals to each of a plurality of channels according to a protocol of the bus system.

14. The bus connection apparatus of claim 10, wherein the decoder allots a channel to the master allowed to use the slaves by decoding the command received from the master allowed to use the slaves, determines which of the slaves use the allotted channel, and generates the information necessary for using the slaves based on the determination results.

15. The bus connection apparatus of claim 10, wherein the slaves comprise memory banks, and the decoder generates address information and control information that specify the reading or writing of data in units of lines on a memory map, which comprises mapping information of the masters and the memory banks, by decoding a command containing information regarding the reading/writing of data from/to the memory banks in units of blocks.

16. The bus connection apparatus of claim 10, wherein the slaves comprise memory banks, and the interface comprises a direct memory access (DMA) allotted to each of the memory banks.

17. The bus connection apparatus of claim 10, wherein the arbitrator determines the master allowed to use the plurality of slaves based on priority levels of the masters.

18. The bus connection apparatus of claim 17, wherein the priority levels of the masters are based on the order in which the commands issued by the masters arrive and the importance of the commands issued buy the masters.

19. A computer-readable recording medium storing a computer program for executing a bus connection method, the bus connection method comprising:
allowing one of a plurality of masters to use a plurality of slaves;
generating information necessary for using the slaves by decoding a command received from the master allowed to use the slaves; and
outputting signals with reference to the generated information according to a protocol of a bus system to which the slaves are connected.
